(19) United States
(12) Patent Application Publication
(10) Pub. No.: US 2013/0114748 A1
(43) Pub. Date: May 9, 2013

(54) Method, Apparatus and Device for Transmitting Data Blocks

(71) Applicants: Keiichi Kubota, Weybridge (GB); Brian Martin, Farnham (GB)

(72) Inventors: Keiichi Kubota, Weybridge (GB); Brian Martin, Farnham (GB)

(73) Assignee: Renesas Mobile Corporation

(21) Appl. No.: 13/290,239

(22) Filed: Nov. 7, 2011

(30) Foreign Application Priority Data
Nov. 4, 2011 (GB) 1119056.8

(51) Int. Cl. H04L 27/00

(52) U.S. Cl. 375/259

(57) ABSTRACT

Sequentially numbered data blocks are transmitted by a first device for receipt by a second device. An indication of non-receipt of one of the plurality of data blocks is received from the second device, which leads to a retransmission pending timer being started if a retransmission pending timer is not already running. The first device records for which of the data blocks an indication of non-receipt has been received whilst the timer is running, and notes for which of those initially non-received data blocks an acknowledgement of receipt is subsequently received. At expiry of the timer, the first device retransmits those of the data blocks that have a sequence number less than the sequence number of the data block that led to the timer being started and for which an indication of non-receipt was received whilst the timer is running and an acknowledgement of receipt was not received.

### TECHNICAL FIELD

The present invention relates to a method, apparatus and a device for transmitting data blocks.

### BACKGROUND

The following abbreviations are used in this specification:

3GPP Third Generation Partnership Project

ACK acknowledgement

AM Acknowledge Mode

DB-DC-HDSPA dual band dual cell HSDPA

DC-HSDPA dual cell HSDPA

eNB evolved Node B

HSDPA high speed downlink packet access

HSPA high speed packet access

HSUPA high-speed uplink packet access

MAC media access control

NACK negative acknowledgement

PDU protocol data unit

PDCP Packet Data Convergence Protocol

RAN radio network access

RLC Radio Link Control

RNC radio network controller

RTT round trip time

SN sequence number

SUFI super field

UE user equipment

UMTS Universal Mobile Telecommunications System

“Wireless devices” include in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. The term “user equipment” is often used to refer to wireless devices in general, and particularly mobile wireless devices.

Wireless networks have in recent years experienced a considerable increase in the amount of data being transmitted to and from wirelessly connected devices or user equipment. This increase in traffic has been mainly due to the rapid and widespread uptake of smart phones, the availability of mobile broadband dongles for computers and affordable rates for consumers. In order to increase the peak data rates per user and make better use of the available network resources, it has been proposed to use two or more carriers (in the downlink direction or uplink direction or both) and/or two or more frequencies or bands (again, in the downlink direction or uplink direction or both) and/or two or more data flows (again, in the downlink direction or uplink direction or both). In simple terms, by using two or more carriers in “carrier aggregation”, a wireless device connects wirelessly using two or more network carriers to increase the peak data rates available and to make better use of the available resources by multiplexing the carriers, and achieves greater spectrum efficiency through joint resource allocation and balancing loads among the downlink and/or uplink carriers. In general, the carriers may be in different but overlapping cells, may use the same or different frequencies, and may or may not use MIMO (multiple-input and multiple-output, i.e. the use of multiple antennas at both the transmitter and receiver to improve communication performance). Similar benefits are achieved with multiflow operation.

These proposals for multi-carrier and/or multi-band and/or multiflow transmissions have application to many network transmission protocols, including wireless network transmission protoc ols in particular.

As a particular example, 3GPP makes use of HSPA which refers to the combination of high-speed downlink packet access (HSDPA) and high-speed uplink packet access (HSUPA). HSPA increases available data rates and also boosts capacity in UMTS networks and provides significant latency reductions. In 3GPP Release-8 and Release-9, the dual cell HSDPA (DC-HSDPA) and dual band DC-HSDPA (or DB-DC-HDSPA) features were introduced. Both these features allow a Node B to serve one or more users in the downlink direction by simultaneous operation of HSDPA on two different carrier frequencies in two geographically overlapping cells, thus improving the user experience across the entire cell coverage area. Whilst initially it was proposed to use two carriers or cells and two frequencies or bands, recent proposals extend this to more than two carriers/cells and more than two frequencies/bands (which will generically be referred to herein as multicarrier and multiband respectively). As a particular example, recent proposals in 3GPP provide for the use of eight network cells for this purpose (termed 8C-HSDPA or 8-Cell High Speed Downlink Packet Access), which in theory could provide a maximum physical layer throughput or bandwidth of 336 Mbps.

As another particular example, there have been proposals in 3GPP for so-called multiflow operation, see for example RP-111375. In this, two data flows are used to transmit data to a wireless device, by using for example simultaneous HSDPA transmission from a pair of cells operating on the same carrier frequency in any given TTI to a particular user (so-called Single-Frequency Dual-Cell aggregation); or by using a dual carrier configuration with two cell pairs, each on their respective carrier frequencies (so-called Dual-Frequency Quad-Cell aggregation); and extensions to these where the two cells in the cell pair of the first case reside in different Node Bs and where the cell pairs in the second case reside in different Node Bs.

A problem can arise in that with multicarrier and multiflow transmissions, the data flows between the transmitter device and the receiver device over the respective carriers can be delayed relative to each other or can pass with different latencies or trip times, which can lead to the so-called skew problem. This is a loss of timing between the transmissions over the plural carriers, which can give rise to a large number of retransmitted data packets or units as the transmitter can assume that these have been lost, which may be unnecessary as the original data transmissions may simply have been delayed. Similarly, where plural frequencies are used in multiband transmissions (whether on the same carrier/cell or different carriers/cells), there can again be a loss of timing, again giving rise to the skew problem and unnecessary retransmissions of data packets.

One proposal to deal with this in the context of multiflow transmissions in 3GPP in particular can be found in R2-115071 of 3GPP TSG-RAN WG2 entitled “Further considerations on the HSDPA Multiflow data split options”. There, in order to minimise these retransmissions, it has been proposed that the radio network controller or RNC keeps track of the respective cells over which the RLC PDUs are transmitted. In this scheme, if a UE reports a RLC NACK (i.e. the UE reports that an expected data unit has not been received) followed by an ACK (for a subsequent data unit), and the RNC internal book-keeping indicates that both PDUs were transmitted over the same cell, then the RNC knows that the NACK refers to a genuine error or loss of packet, and can trigger retransmission. In other cases, the RNC does not know whether a NACK refers to skew caused by the multiflow transmission or a genuine reception error. In this case, it starts a retransmission delay timer in order to avoid unnecessary retransmissions. If this timer expires before reception of a corresponding ACK for that PDU, the RNC triggers retransmission of the PDU. However, this proposal is extremely complicated and unwieldy for the network operator to implement it in practice.

Whilst discussed principally herein in the context of the downlink to a wireless device or UE, it will be understood that the principles discussed herein are equally applicable to transmissions in the uplink direction from the wireless device or UE.

### SUMMARY

In a first exemplary embodiment of the invention, there is a method of transmitting data blocks from a first device to a second device, the method comprising:

the first device arranging for transmission of a plurality of sequentially numbered data blocks for receipt by a second device;

the first device receiving from the second device an indication of non-receipt of one of the plurality of data blocks;

the first device always starting a retransmission pending timer upon receipt of said indication of non-receipt of one of the plurality of data blocks if a retransmission pending timer associated with receipt of an indication of non-receipt of one of the plurality of data blocks is not already running;

the first device recording for which of the transmitted plurality of data blocks an indication of non-receipt has been received from the second device whilst the retransmission pending timer is running,

the first device further noting for which ones of those transmitted plurality of data blocks, for which an indication of non-receipt has been received from the second device whilst the retransmission pending timer is running, an acknowledgement of receipt is subsequently received from the second device whilst the retransmission pending timer is running,

and, at expiry of the retransmission pending timer, the first device retransmitting those of the transmitted plurality of data blocks that have a sequence number less than the sequence number of said one data block for which receipt of the indication of non-receipt led to the retransmission pending timer being started and for which an indication of non-receipt was received from the second device whilst the retransmission pending timer is running and an acknowledgement of receipt was not received from the second device whilst the retransmission pending timer was running.

In a second exemplary embodiment of the invention, there is apparatus for a first device for arranging for transmission of data blocks from the first device to a second device, the apparatus comprising:

at least one processor;

and at least one memory including computer program code;

the at least one memory and the computer program code being configured to, with the at least one processor, cause:

the first device to arrange for transmission of a plurality of sequentially numbered data blocks for receipt by a second device;

the first device always to start a retransmission pending timer upon receipt from a said second device of an indication of non-receipt of one of the plurality of data blocks if a retransmission pending timer associated with receipt of an indication of non-receipt of one of the plurality of data blocks is not already running;

the first device to record for which of the transmitted plurality of data blocks an indication of non-receipt has been received from a said second device whilst the retransmission pending timer is running,

the first device further to note for which ones of those transmitted plurality of data blocks, for which an indication of non-receipt has been received from a said second device whilst the retransmission pending timer is running, an acknowledgement of receipt is subsequently received from a said second device whilst the retransmission pending timer is running,

and, at expiry of the retransmission pending timer, the first device to retransmit those of the transmitted plurality of data blocks that have a sequence number less than the sequence number of said one data block for which receipt of the indication of non-receipt led to the retransmission pending timer being started and for which an indication of non-receipt was received from a said second device whilst the retransmission pending timer is running and an acknowledgement of receipt was not received from a said second device whilst the retransmission pending timer was running.

In a third exemplary embodiment of the invention, there is a device for causing transmission of data blocks to a second device, the device comprising at least one processor; and at least one memory including computer program code; the at least one memory and the computer program code being configured to, with the at least one processor, cause:

the device to arrange for transmission of a plurality of sequentially numbered data blocks for receipt by a second device;

the device always to start a retransmission pending timer upon receipt from a said second device of an indication of non-receipt of one of the plurality of data blocks if a retransmission pending timer associated with receipt of an indication of non-receipt of one of the plurality of data blocks is not already running;

the device to record for which of the transmitted plurality of data blocks an indication of non-receipt has been received from a said second device whilst the retransmission pending timer is running,

the device further to note for which ones of those transmitted plurality of data blocks, for which an indication of non-receipt has been received from a said second device whilst the retransmission pending timer is running, an acknowledgement of receipt is subsequently received from a said second device whilst the retransmission pending timer is running,

and, at expiry of the retransmission pending timer, the device to retransmit those of the transmitted plurality of data blocks that have a sequence number less than the sequence number of said one data block for which receipt of the indication of non-receipt led to the retransmission pending timer being started and for which an indication of non-receipt was received from a said second device whilst the retransmission pending timer is running and an acknowledgement of receipt was not received from a said second device whilst the retransmission pending timer was running.

There is also provided a non-transitory computer-readable storage medium comprising a set of computer-readable instructions stored thereon, which, when executed by a processing system, cause the processing system to carry out a method as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically a user equipment and network apparatus;

FIG. 2 shows schematically HSDPA multiflow data transmission; and

FIG. 3 shows schematically an example of a method according to an embodiment of the present invention.

### DETAILED DESCRIPTION

Embodiments described herein provide for relatively simple operation at the first device whilst dealing with the skew problem mentioned above and keeping down unnecessary retransmission of data blocks. In a particular embodiment, the sequence number may be the sequence number of the 3GPP RLC PDU format.

In an embodiment, if a first retransmission pending timer associated with receipt of an indication of non-receipt of one of the plurality of data blocks is already running, the first device starts a second retransmission pending timer upon receipt of an indication of non-receipt of another of the plurality of data blocks and the sequence number of said another of the plurality of data blocks is greater than the sequence number of said one of the plurality of data blocks for which receipt of the indication of non-receipt led to the first retransmission pending timer being started,

wherein at expiry of the first retransmission pending timer, the first device retransmits those of the transmitted plurality of data blocks for which an indication of non-receipt was received from the second device whilst the first retransmission pending timer was running and for which their sequence number is less than the sequence number of said one of the plurality of data blocks and an acknowledgement of receipt was not received from the second device whilst the first retransmission pending timer was running, and

wherein at expiry of the second retransmission pending timer, the first device retransmits those of the transmitted plurality of data blocks for which an indication of non-receipt was received from the second device whilst the second retransmission pending timer was running and for which their sequence number is greater than the sequence number of said one of the plurality of data blocks and less than the sequence number of said another of the plurality of data blocks and an acknowledgement of receipt was not received from the second device whilst the first retransmission pending timer was running. This accommodates the case where multiple indications of non-receipt are received from the second device in an efficient and effective manner.

In an embodiment, some of the data blocks are transmitted wirelessly using a first cell and others of the data blocks are transmitted using a second cell. In an embodiment, some of the data blocks are transmitted wirelessly using a first frequency and others of the data blocks are transmitted wirelessly using a second frequency. These various embodiments allow application to various cases that have been proposed for carrier aggregation, including the use of two or more carriers (in the downlink direction or uplink direction or both) and/or two or more frequencies or bands (again, in the downlink direction or uplink direction or both). In an embodiment, some of the data blocks are transmitted wirelessly using a first Node B which services a first network cell and others of the data blocks are transmitted wirelessly using a second Node B which services a second network cell, the Node Bs being under control of the same Radio Network Controller. This embodiment is particularly useful for HSDPA multiflow operation.

In an embodiment, the length of time for the retransmission pending timer is configurable by an operator of the network over which the data blocks are transmitted. This allows the operator to fine-tune and optimise the timer according to various criteria.

In an embodiment, the length of time for the retransmission pending timer is set taking into account status prohibit timer duration and the time duration for maximum MAC-ehs retransmissions. This allows the status prohibit timer duration to be minimised, which is particularly useful for increasing data throughput in some applications, including in particular 8C-HSDPA operation.

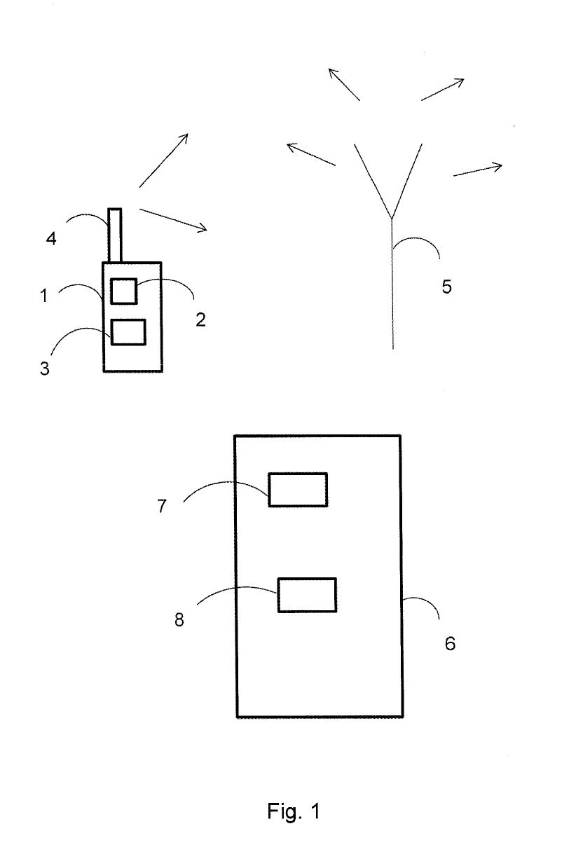

FIG. 1 shows schematically a user equipment or wireless device, in this case in the form of a mobile phone/smartphone 1. The user equipment 1 contains the necessary radio module 2, processor(s) and memory/memories 3, antenna 4, etc. to enable wireless communication with the network. The user equipment 1 in use is in communication with a radio mast 5. As a particular example in the context of UMTS (Universal Mobile Telecommunications System), there may be a network control apparatus 6 (which may be constituted by for example a so-called Radio Network Controller) operating in conjunction with one or more Node Bs (which, in many respects, can be regarded as “base stations”). As another example, LTE (Long Term Evolution) makes use of a so-called Evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. The network control apparatus 6 (of whatever type) may have its own processor(s) 7 and memory/memories 8, etc.

As mentioned, the proposals herein relating to multicarrier and/or multiband transmissions and/or multiflow have application to many network transmission protocols, including wireless network transmission protocols in particular. Nevertheless, as a particular example, much of the following description is given in respect of a 3GPP system. Also, much of the following is given in respect of downlink transmissions from a network to a UE, it being understood that these proposals can equally be applied to uplink transmissions from the UE to the network.

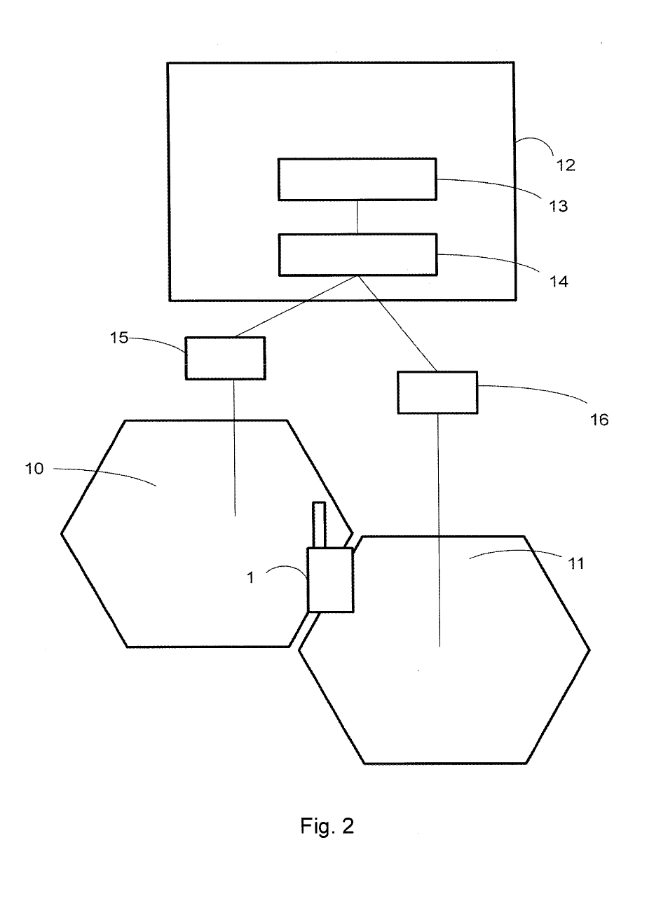

FIG. 2 shows schematically HSDPA multiflow data transmission. In this example, a network uses two HSDPA cells 10,11 to transmit downlink data to one UE 1. The network apparatus includes a RNC 12, which makes use of the PDCP or Packet Data Convergence Protocol 13 for radio link control or RLC 14 to control the sending and reception of data and control packets to and from the UE 1. In this example, using two HSDPA cells 10,11, a respective Node B 15,16 services the respective HSDPA cells 10,11. In practice, if data delivery on one of the HSDPA cells 10 is delayed (e.g. some MAC PDUs are being re-transmitted due to a poor radio condition) and the other HSDPA cell 11 continues data delivery without any delay, the UE will receive downlink RLC PDUs that are out of sequence. As a result, and as part of the flow control mechanism in use, the UE 1 will send negative acknowledgement (NACKs) in respect of the RLC PDUs that have not yet been received by the UE 1. However, if the buffered data on the one HSDPA cell 10 is delivered to the UE 1 later (i.e. in this example, the retransmitted MAC PDUs reach the UE 1 eventually), then the RNC 6 does not actually need to have retransmitted the NACKed RLC PDUs. Thus, the negative acknowledgement(s) may trigger unnecessary RLC PDU retransmissions. The unnecessarily retransmitted RLC PDUs waste downlink bandwidth and so compromise downlink throughput.

Similarly, where two different frequency bands are used (whether or not on the same carrier or cell), a similar problem can arise. In particular, skewed RLC PDUs, which have different timings than expected, might be seen when downlink data is sent over different frequency bands because the RF performance may be different between two different frequency bands. As a particular example, DB-DC-HSDPA (Rel-9) and 4C-HSDPA (Rel-10) each use two different frequencies and one serving HS-DSCH cell might have a data delivery delay whereas the other serving HS-DSCH cell does not have any data delivery delay.

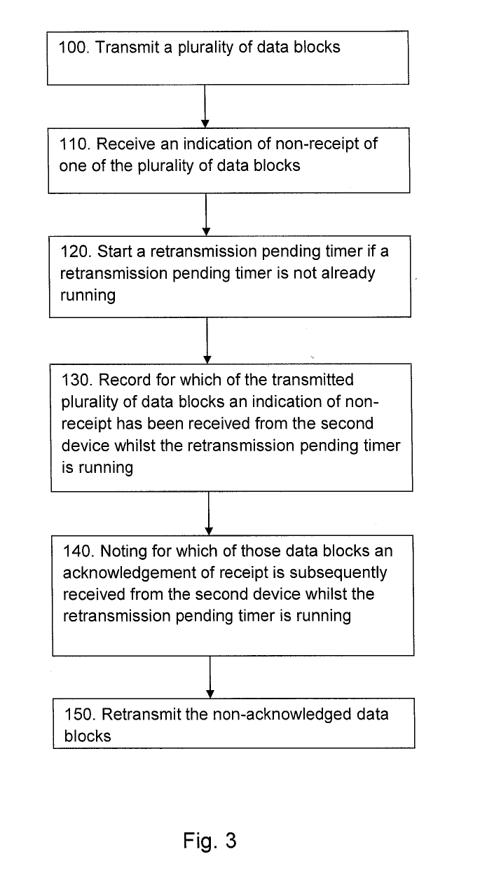

Referring to FIG. 3, an example of a method according to an embodiment of the present invention operates as follows. At 100, a first device arranges for transmission of a plurality of data blocks to a second device. At 110, the first device receives from the second device an indication of non-receipt of one of the plurality of transmitted data blocks. At 120, if a retransmission pending timer associated with receipt of an indication of non-receipt of one of the plurality of data blocks is not already running, then the first device always starts a retransmission pending timer upon receipt of said indication of non-receipt of one of the plurality of data blocks. In other words, in this example, a retransmission pending timer is always started upon receipt of an indication of non-receipt of one of the plurality of data blocks unless such a timer is already running (having already been triggered by earlier receipt of an indication of non-receipt of one of the plurality of data blocks).

Having stated the timer, the first device at 130 records for which of the transmitted plurality of data blocks an indication of non-receipt has been received from the second device whilst the timer is running. At 140, the first device notes for which ones of those transmitted plurality of data blocks, for which an indication of non-receipt has been received from the second device whilst the timer is running, an acknowledgement of receipt is subsequently received from the second device whilst the timer is running. Then, at 150, at expiry of the timer, the first device retransmits those of the transmitted plurality of data blocks for which an indication of non-receipt was received from the second device whilst the timer was running and an acknowledgement of receipt was not received from the second device whilst the timer was running, i.e. the first device retransmits the non-acknowledged data blocks.

This provides for relatively simple operation at the first device whilst dealing with the skew problem mentioned above and keeping down unnecessary retransmission of data blocks. The first device only needs to check whether a retransmission pending timer is already running and, if not, then it always starts a retransmission pending timer upon receipt of an indication of non-receipt of a transmitted data block by the second device, and records for which of the transmitted data blocks a non-receipt message has been received and for which an acknowledgement of receipt has not been subsequently received. In this example, there is no attempt to record how the data blocks were actually transmitted and whether for example they were sent over different carriers or cells, or using different frequencies, in the case of wireless cellular transmissions, which in practice is difficult and complex to implement.

In the above, the “first device” may be a network entity, such as a base station or a network control apparatus (which may be constituted by for example a so-called Radio Network Controller) operating in conjunction with one or more Node Bs (which, in many respects, can be regarded as “base stations”), an Evolved Node B (eNB), etc., and the second device may be a UE or wireless device. In such a case, the transmissions from the first device are downlink transmissions to the second device. The converse may also apply, such that the first device is a UE and the second device a network entity and the transmissions from the first device are uplink transmissions to the second device. The method may be used for both uplink and downlink. Different frequencies and/or carriers may be used for the transmissions of different data blocks.

In a particular example suitable for 3GPP, the transmitter RLC entity has a retransmission pending timer. The transmitter or downlink RLC entity on the network NW side may be for example a RNC for UMTS or an eNodeB for LTE. The transmitter RLC entity starts the retransmission pending timer when it receives any NACK from a UE in respect of a PDU and a retransmission pending timer is not already running (because of earlier receipt of a NACK in respect of a PDU). The RLC entity does not retransmit any NACKed RLC PDUs until expiry of the retransmission pending timer. If the transmitter RLC entity receives any ACK in respect of NACKed PDUs while the timer is running, then it updates the NACKed RLC PDU records to show that those NACKed PDUs have in fact been acknowledged as received by the UE. Once the timer expires, the transmission RLC entity starts retransmitting the NACKed RLC PDUs (for which an ACK was not subsequently received) for receipt by the UE. This allows a little time for ACKs to be received in respect of PDUs that were initially NACKed but which might simply have been delayed in transmission/transit and which eventually do reach the UE.

This therefore deals with the skew problem in 3GPP whilst keeping down the number of unnecessary RLC PDU retransmissions and this helps to avoid or minimise any performance degradation. There is no impact on the UE as no changes in operation of the UE are required, and thus this can be applied for networks that service older, legacy UEs without problem. The RLC capacity can therefore be increased, in line with the objective of using multiband and multicarrier transmissions. It may be noted that retransmissions will be delayed for the case of genuine data drop due to the introduction of the retransmission pending timer, which delays retransmission of any dropped PDUs. However, this is not considered to be a particular problem as data throughput for those PDUs has already been compromised.

In practice, in an embodiment, once a retransmission pending timer has been started at the transmitter device upon receipt of a NACK for a PDU, further NACKs for other PDUs may be received at the transmitter device. To handle the receipt of multiple NACKs, the retransmission pending timer can be associated with the NACKed PDU that has the largest sequence number or SN. When the timer expires, then the transmitter RLC retransmits the NACKed RLC PDUs having sequence numbers up to the sequence number of the PDU that caused the associated timer to be started (assuming those PDUs have not subsequently had ACKs transmitted by the receiving device and received at the transmitter RLC). So for example, if the transmitter RLC receives another NACK that relates to a PDU having a greater RLC SN than a previously received NACK (which is associated with a retransmission pending timer that is already running), then another retransmission pending timer is started, associated with the new, larger NACKed RLC SN. If on the other hand the transmitter receives a NACK for a PDU having a sequence number smaller than or equal to the RLC SN associated with the other retransmission pending timer, then the transmitter does not start another timer. Subsequently received NACKs for PDUs having a sequence number less than the sequence number of the PDU that is associated with the first timer are also associated with the first timer, and those PDUs are retransmitted at expiry of that first timer (assuming that they have not been ACKed in the meantime). Similarly, subsequently received NACKs for PDUs having a sequence number greater than the sequence number of the PDU that is associated with the first timer but less than the sequence number of the PDU that is associated with the second timer are also associated with the second timer, and those PDUs are retransmitted at expiry of that second timer (assuming that they have not been ACKed in the meantime). This starting of further timers and associating NACKed PDUs with those further timers is extended as necessary if further NACKs are received for PDUs having a SN greater than one that had already caused a timer to be started.

(In detail on flow control, a so-called service data unit (SDU) is typically segmented to form a group of RLC PDUs, which in this context are packets of data to be individually transmitted. In AM (Acknowledge Mode) RLC, they are also referred to as AMD PDUs (Acknowledged Mode Data PDUs). The transmitter keeps a note of the group of RLC PDUs that need to be transmitted and acknowledged in the form of a transmission window, which allows control of the number of RLC PDUs being sent by the transmitter to the receiver to avoid causing a receiving buffer at the receiver to overflow. If the transmitter receives a positive acknowledgement of receipt of a particular RLC PDU from the receiver, the transmitter can update the transmission window by removing the record of that RLC PDU and adding a record of a new RLC PDU to be transmitted. A negative acknowledgement or NACK is sent if an expected PDU has not been received, this negative acknowledgement being in the form of a status PDU such as List SUFI, Bitmap SUFI or Relative List SUFI.)

The length of time for the retransmission pending timer may be configured by the network operator and may be fine-tuned according to the RTT or round trip time and the expected delay in the lower layer. As an example, the expected lower layer delay may be the existing status prohibit timer duration+the time duration for maximum MAC-ehs retransmissions (MAC-ehs being a Medium Access Control entity that optimised for HSPA+). The status prohibit timer is used by the RLC as part of a status prohibit mechanism to regulate the transmission of the status reports. When a status report is sent by the receiver, the subsequent report should normally not be sent before waiting for at least one RTT. This is because each status report contains the NACKs corresponding to all outstanding missing packets, and spurious retransmissions can be triggered if sufficient time is not allowed for a retransmission. The status prohibit timer is therefore normally set to a value slightly longer than the mean RTT to allow the RLC transmitter to perform a retransmission before a new NACK is generated. The use of the retransmission pending timer allows the status prohibit timer to be set to a very small value.

In this regard, for 8C-HSDPA operation (Rel-11), it is being discussed whether or not the RLC window size needs to be enhanced to achieve the theoretical maximum throughput (which is 336 Mbps for 8C, as mentioned above). The RLC window is a concept used for flow control in certain scenarios and defines a particular set of RLC PDUs that the transmitter is attempting to transmit to a receiver at any particular time. The RLC throughput can be obtained by the following formula:

RLC throughput=(RLC window size x RLC PDU size)/(RTT+status prohibit timer duration/2)

where RTT is the round trip time.

Typical values are:

RLC window size=2047

RLC PDU size=12000 bits

RTT=70 ms

status prohibit timer=40 ms

With these values, the formula gives 272.93 Mbps, which is far from the theoretical maximum of 336 Mbps. RTT has already been set to a quite challenging value and RLC window size and RLC PDU size have already been set to the maximum values.

Thus, referring to the above discussion of setting the length of time for the retransmission pending timer, reducing the duration of the status prohibit timer has a benefit in achieving greater RLC throughput. For example, if the status prohibit timer is set to 10 ms say, then the current RLC protocol can support up to 327.52 Mbps, which is quite close to the 8C-HSDPA theoretical maximum physical channel throughput. It may be noted however that if the status prohibit timer duration is set to a very small value, this may lead to unnecessary RLC PDU retransmissions and again it will compromise the downlink throughput, and so a balance or compromise for the value may be found.

Thus, embodiments of the present invention deal with the skew problem whilst keeping down the number of unnecessary RLC PDU retransmissions, which helps to avoid or minimise any performance degradation. There is no impact on the UE as no changes in operation of the UE are required, and thus this can be applied for networks that service older, legacy UEs without problem and UEs do not have to be modified or updated. The RLC capacity can therefore be increased, in line with the objective of using multib and and multicarrier transmissions. For the particular case of 8C-HSDPA, it becomes easier to achieve higher throughput very close to the theoretical maximum physical channel throughput as the status prohibit timer duration is set to a small value.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of transmitting data blocks from a first device to a second device, the method comprising:
the first device arranging for transmission of a plurality of sequentially numbered data blocks for receipt by a second device;
the first device receiving from the second device an indication of non-receipt of one of the plurality of data blocks;
the first device always starting a retransmission pending timer upon receipt of said indication of non-receipt of one of the plurality of data blocks if a retransmission pending timer associated with receipt of an indication of non-receipt of one of the plurality of data blocks is not already running;
the first device recording for which of the transmitted plurality of data blocks an indication of non-receipt has been received from the second device whilst the retransmission pending timer is running,
the first device further noting for which ones of those transmitted plurality of data blocks, for which an indication of non-receipt has been received from the second device whilst the retransmission pending timer is running, an acknowledgement of receipt is subsequently received from the second device whilst the retransmission pending timer is running,
and, at expiry of the retransmission pending timer, the first device retransmitting those of the transmitted plurality of data blocks that have a sequence number less than the sequence number of said one data block for which receipt of the indication of non-receipt led to the retransmission pending timer being started and for which an indication of non-receipt was received from the second device whilst the retransmission pending timer is running and an acknowledgement of receipt was not received from the second device whilst the retransmission pending timer was running.

2. A method according to claim 1, wherein if a first retransmission pending timer associated with receipt of an indication of non-receipt of one of the plurality of data blocks is already running, the first device starts a second retransmission pending timer upon receipt of an indication of non-receipt of another of the plurality of data blocks and the sequence number of said another of the plurality of data blocks is greater than the sequence number of said one of the plurality of data blocks for which receipt of the indication of non-receipt led to the first retransmission pending timer being started,
wherein at expiry of the first retransmission pending timer, the first device retransmits those of the transmitted plurality of data blocks for which an indication of non-receipt was received from the second device whilst the first retransmission pending timer was running and for which their sequence number is less than the sequence number of said one of the plurality of data blocks and an acknowledgement of receipt was not received from the second device whilst the first retransmission pending timer was running, and
wherein at expiry of the second retransmission pending timer, the first device retransmits those of the transmitted plurality of data blocks for which an indication of non-receipt was received from the second device whilst the second retransmission pending timer was running and for which their sequence number is greater than the sequence number of said one of the plurality of data blocks and less than the sequence number of said another of the plurality of data blocks and an acknowledgement of receipt was not received from the second device whilst the first retransmission pending timer was running.

3. A method according to claim 1, wherein some of the data blocks are transmitted wirelessly using a first cell and others of the data blocks are transmitted using a second cell.

4. A method according to claim 1, wherein some of the data blocks are transmitted wirelessly using a first frequency and others of the data blocks are transmitted wirelessly using a second frequency.

5. A method according to claim 1, wherein some of the data blocks are transmitted wirelessly using a first Node B which services a first network cell and others of the data blocks are transmitted wirelessly using a second Node B which services a second network cell, the Node Bs being under control of the same Radio Network Controller.

6. A method according to claim 1, wherein the length of time for the retransmission pending timer is configurable by an operator of the network over which the data blocks are transmitted.

7. A method according to claim 1, wherein the length of time for the retransmission pending timer is set taking into account status prohibit timer duration and the time duration for maximum MAC-ehs retransmissions.

8. Apparatus for a first device for arranging for transmission of data blocks from the first device to a second device, the apparatus comprising:
at least one processor;
and at least one memory including computer program code;
the at least one memory and the computer program code being configured to, with the at least one processor, cause:
the first device to arrange for transmission of a plurality of sequentially numbered data blocks for receipt by a second device;
the first device always to start a retransmission pending timer upon receipt from a said second device of an indication of non-receipt of one of the plurality of data blocks if a retransmission pending timer associated with receipt of an indication of non-receipt of one of the plurality of data blocks is not already running;
the first device to record for which of the transmitted plurality of data blocks an indication of non-receipt has been received from a said second device whilst the retransmission pending timer is running,
the first device further to note for which ones of those transmitted plurality of data blocks, for which an indication of non-receipt has been received from a said second device whilst the retransmission pending timer is running, an acknowledgement of receipt is subsequently received from a said second device whilst the retransmission pending timer is running,
and, at expiry of the retransmission pending timer, the first device to retransmit those of the transmitted plurality of data blocks that have a sequence number less than the sequence number of said one data block for which receipt of the indication of non-receipt led to the retransmission pending timer being started and for which an indication of non-receipt was received from a said second device whilst the retransmission pending timer is running and an acknowledgement of receipt was not received from a said second device whilst the retransmission pending timer was running.

9. Apparatus according to claim 8, wherein if a first retransmission pending timer associated with receipt of an indication of non-receipt of one of the plurality of data blocks is already running, the first device is arranged to start a second retransmission pending timer upon receipt of an indication of non-receipt of another of the plurality of data blocks and the sequence number of said another of the plurality of data blocks is greater than the sequence number of said one of the plurality of data blocks for which receipt of the indication of non-receipt led to the first retransmission pending timer being started,
wherein at expiry of the first retransmission pending timer, the first device is arranged to retransmit those of the transmitted plurality of data blocks for which an indication of non-receipt was received from a said second device whilst the first retransmission pending timer was running and for which their sequence number is less than the sequence number of said one of the plurality of data blocks and an acknowledgement of receipt was not received from a said second device whilst the first retransmission pending timer was running, and
wherein at expiry of the second retransmission pending timer, the first device is arranged to retransmit those of the transmitted plurality of data blocks for which an indication of non-receipt was received from a said second device whilst the second retransmission pending timer was running and for which their sequence number is greater than the sequence number of said one of the plurality of data blocks and less than the sequence number of said another of the plurality of data blocks and an acknowledgement of receipt was not received from a said second device whilst the first retransmission pending timer was running.

10. Apparatus according to claim 8, arranged such that some of the data blocks are transmitted wirelessly using a first cell and others of the data blocks are transmitted using a second cell.

11. Apparatus according to claim 8, arranged such that some of the data blocks are transmitted wirelessly using a first frequency and others of the data blocks are transmitted wirelessly using a second frequency.

12. Apparatus according to claim 8, arranged such that some of the data blocks are transmitted wirelessly using a first Node B which services a first network cell and others of the data blocks are transmitted wirelessly using a second Node B which services a second network cell, the Node Bs being under control of the same Radio Network Controller.

13. Apparatus according to claim 8, arranged such that the length of time for the retransmission pending timer is configurable by an operator of the network over which the data blocks are transmitted.

14. Apparatus according to claim 8, arranged such that the length of time for the retransmission pending timer is set taking into account status prohibit timer duration and the time duration for maximum MAC-ehs retransmissions.

15. A device for causing transmission of data blocks to a second device, the device comprising at least one processor; and at least one memory including computer program code; the at least one memory and the computer program code being configured to, with the at least one processor, cause:
the device to arrange for transmission of a plurality of sequentially numbered data blocks for receipt by a second device;
the device always to start a retransmission pending timer upon receipt from a said second device of an indication of non-receipt of one of the plurality of data blocks if a retransmission pending timer associated with receipt of an indication of non-receipt of one of the plurality of data blocks is not already running;
the device to record for which of the transmitted plurality of data blocks an indication of non-receipt has been received from a said second device whilst the retransmission pending timer is running,
the device further to note for which ones of those transmitted plurality of data blocks, for which an indication of non-receipt has been received from a said second device whilst the retransmission pending timer is running, an acknowledgement of receipt is subsequently received from a said second device whilst the retransmission pending timer is running,
and, at expiry of the retransmission pending timer, the device to retransmit those of the transmitted plurality of data blocks that have a sequence number less than the sequence number of said one data block for which receipt of the indication of non-receipt led to the retransmission pending timer being started and for which an indication of non-receipt was received from a said second device whilst the retransmission pending timer is running and an acknowledgement of receipt was not received from a said second device whilst the retransmission pending timer was running.

16. A device according to claim 15, wherein if a first retransmission pending timer associated with receipt of an indication of non-receipt of one of the plurality of data blocks is already running, the device is arranged to start a second retransmission pending timer upon receipt of an indication of non-receipt of another of the plurality of data blocks and the sequence number of said another of the plurality of data blocks is greater than the sequence number of said one of the plurality of data blocks for which receipt of the indication of non-receipt led to the first retransmission pending timer being started,
wherein at expiry of the first retransmission pending timer, the device is arranged to retransmit those of the transmitted plurality of data blocks for which an indication of non-receipt was received from a said second device whilst the first retransmission pending timer was running and for which their sequence number is less than the sequence number of said one of the plurality of data blocks and an acknowledgement of receipt was not received from a said second device whilst the first retransmission pending timer was running, and
wherein at expiry of the second retransmission pending timer, the device is arranged to retransmit those of the transmitted plurality of data blocks for which an indication of non-receipt was received from a said second device whilst the second retransmission pending timer was running and for which their sequence number is greater than the sequence number of said one of the plurality of data blocks and less than the sequence number of said another of the plurality of data blocks and an acknowledgement of receipt was not received from a said second device whilst the first retransmission pending timer was running.

17. A device according to claim 15, arranged such that some of the data blocks are transmitted wirelessly using a first cell and others of the data blocks are transmitted using a second cell.

18. A device according to claim 15, arranged such that some of the data blocks are transmitted wirelessly using a first frequency and others of the data blocks are transmitted wirelessly using a second frequency.

19. A device according to claim 15, arranged such that some of the data blocks are transmitted wirelessly using a first Node B which services a first network cell and others of the data blocks are transmitted wirelessly using a second Node B which services a second network cell, the Node Bs being under control of the same Radio Network Controller.

20. A device according to claim 15, arranged such that the length of time for the retransmission pending timer is configurable by an operator of the network over which the data blocks are transmitted.

21. A device according to claim 15, arranged such that the length of time for the retransmission pending timer is set taking into account status prohibit timer duration and the time duration for maximum MAC-ehs retransmissions.

22. A non-transitory computer-readable storage medium comprising a set of computer-readable instructions stored thereon, which, when executed by a processing system, cause the processing system to carry out a method according to claim 1.
